(19) United States
(12) Patent Application Publication
(10) Pub. No.: US 2018/0034851 A1
(43) Pub. Date: Feb. 1, 2018

(54) ELECTRONIC CONTROL APPARATUS

(71) Applicant: DENSO CORPORATION, Kariya-city (JP)

(72) Inventors: Satoshi KANAMARU, Kariya-city (JP); Masayoshi KONDO, Kariya-city (JP)

(21) Appl. No.: 15/497,297

(22) Filed: Apr. 26, 2017

(30) Foreign Application Priority Data
Jul. 27, 2016 (JP) 2016-147327

(51) Int. Cl. H04L 29/06; H04B 1/38; H04L 12/22

(52) U.S. Cl. CPC H04L 63/1466; H04L 63/1491; H04L 63/1408; H04L 12/22; H04B 1/38

(57) ABSTRACT

An electronic control apparatus includes a dummy data setting section and a transmission section. The dummy data setting section sets a dummy data in a free area of a format area that is previously defined. The electronic control apparatus configures a communication system as a transmission node and stores normal data in the format area. The free area is a rest of the format area after the transmission node stores the normal data in the format area. The communication system further includes a reception node. The transmission section transmits the normal data together with the dummy data to the reception node via a network. The reception node receives the normal data together with the dummy data via the network.

### CROSS REFERENCE TO RELATED APPLICATION

This application is based on Japanese Patent Application No. 2016-147327 filed on Jul. 27, 2016, the disclosure of which is incorporated herein by reference.

### TECHNICAL FIELD

The present disclosure relates to an electronic control apparatus which performs data communication through a network.

### BACKGROUND

In a data communication, a malicious third party may connect an unauthorized device to a network and exploit information when the unauthorized device is capable of being easily connected to the network and a protocol of the network is publicly known. Thus, a security technology is an important technology, and various kinds of security technologies are proposed to improve network security as disclosed in JP 2005-278007 A.

### SUMMARY

In view of the foregoing difficulties, it is desirable to provide a countermeasure even when an unauthorized device is connected to a closed network and readout of data from the closed network is impossible to be avoided.

It is an object of the present disclosure to provide an electronic control apparatus configuring a communication system which makes normal data transmitted or received in a transmission and reception process difficult to be analyzed even when an unauthorized device is connected to a network and reads out the normal data from the network.

According to an aspect of the present disclosure, an electronic control apparatus includes a dummy data setting section and a transmission section. The dummy data setting section sets a dummy data in a free area of a format area that is previously defined. The electronic control apparatus configures a communication system as a transmission node and stores normal data in the format area. The free area is a rest of the format area after the transmission node stores the normal data in the format area. The communication system further includes a reception node. The transmission section transmits the normal data together with the dummy data to the reception node via a network. The reception node receives the normal data together with the dummy data via the network.

When an unauthorized device is connected to a network for malicious data reading, the unauthorized device reads the normal data together with the dummy data. Thus, it is difficult for the unauthorized device to analyze which data is the normal data, and the unauthorized device may have difficulty in specifying and reading the normal data correctly. Thus, even when the unauthorized device is connected to the network for malicious reading of the normal data, it is difficult for the unauthorized device to analyze which data is the normal data.

In the above electronic control apparatus, when storing the dummy data, the free area previously given in the format area is utilized. So, an increase of communication information can be avoided, and accordingly, network communication traffic of the onboard network is prevented from being increased to the utmost extent.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing a configuration of a communication system according to a first embodiment of the present disclosure;

FIG. 2A is a diagram showing an electrical configuration of an electronic control unit (ECU);

FIG. 2B is a diagram showing functions of the electrical configuration of ECU;

FIG. 3 is a diagram showing a partial configuration of a communication data format of a data frame employed in a controller area network (CAN);

FIG. 4 is a diagram showing a usage state of each bit for each CANID which is stored in a management table;

FIG. 5 is a flowchart showing a process executed by a transmission node;

FIG. 6 is a flowchart showing an update process of a dummy data;

FIG. 7 is a diagram showing a transmission and reception process between the transmission node and a reception node;

FIG. 8 is a diagram showing a process executed by the reception node;

FIG. 9 is a diagram showing a process executed by an unauthorized device; and

FIG. 10 is a flowchart showing an update process of a dummy data according to a second embodiment of the present disclosure.

### DETAILED DESCRIPTION

Hereinafter, respective embodiments will be described with reference to the drawings. In the respective embodiments below, same or equivalent portions are indicated by same reference symbols in the drawings and a same description applies to a portion indicated by the same reference symbol.

### First Embodiment

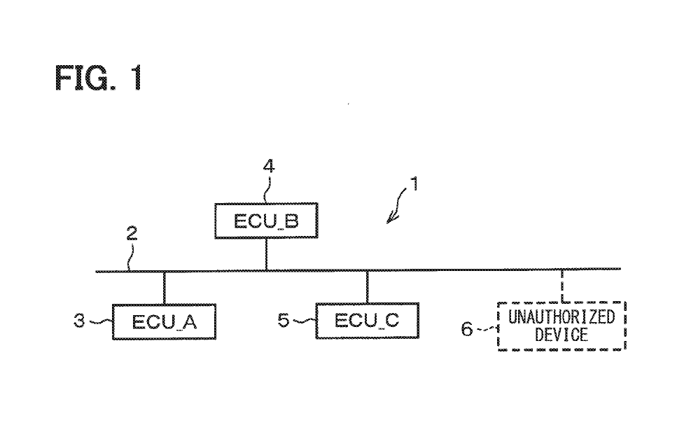

FIG. 1 through FIG. 9 are diagrams according to a first embodiment of the present disclosure. FIG. 1 shows a configuration of a communication system 1. In an onboard network 2, CAN protocol may be employed. Herein, CAN is a registered trademark. CAN is a closed onboard network employing a communication protocol defined for transmitting data among interconnected devices. Various ECUs, that is, ECU_A 3, ECU_B 4, and ECU_C 5 are connected to the onboard network 2. Hereinafter, ECU_A 3, ECU_B 4, and ECU_C 5 are referred to as ECU 3, ECU 4, and ECU 5, respectively. The ECU 3 through ECU 5 are connected to the onboard network 2, and they are capable of communicating with each other. These multiple ECU 3 through ECU 5 cooperate with each other and control various functions in a vehicle. A malicious third party may connect an unauthorized device to the onboard network 2. Thus, in FIG. 1, the unauthorized device 6 is shown by a broken line.

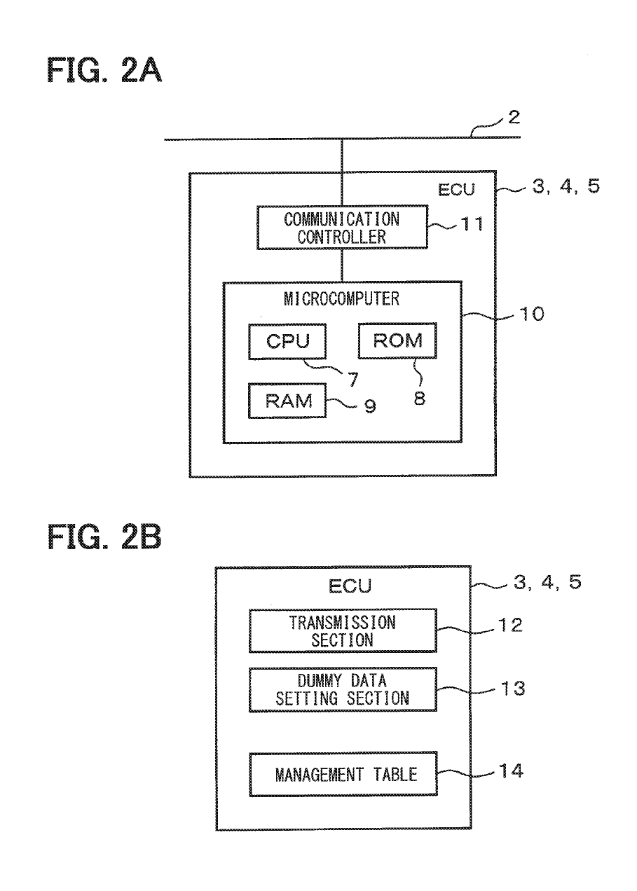

As shown in FIG. 2A, each of the ECUs 3, 4, 5 includes a microcomputer 10 and a communication controller 11 for CAN. The microcomputer 10 includes a central processing unit (CPU) 7, a read-only memory (ROM) 8, a random access memory (RAM) 9, and an additional memory, e.g., back-up RAM, electrically erasable programmable read-only memory (EEPROM) or the like. The additional memory is not shown in FIG. 2A. Hereafter, ROM 8, RAM 9, and the additional memory are collectively referred to as a memory.

The communication controller 11 communicates with the onboard network 2 via, for example, CAN. The microcomputer 10 of each ECU 3, 4, 5 is connected with the communication controller 11, and communicates with other ECUs connected to the onboard network 2. For example, the microcomputer 10 of the ECU 3 communicates with ECUs 4, 5 connected to the onboard network 2. FIG. 2B shows a function of each ECU 3, 4, 5. The CPU 7 of each ECU 3, 4, 5 functions as a transmission section 12 and a dummy data setting section 13 by running a program stored in the memory. The memory of each ECU 3, 4, 5 has a storing area for storing a management table 14 of CAN format.

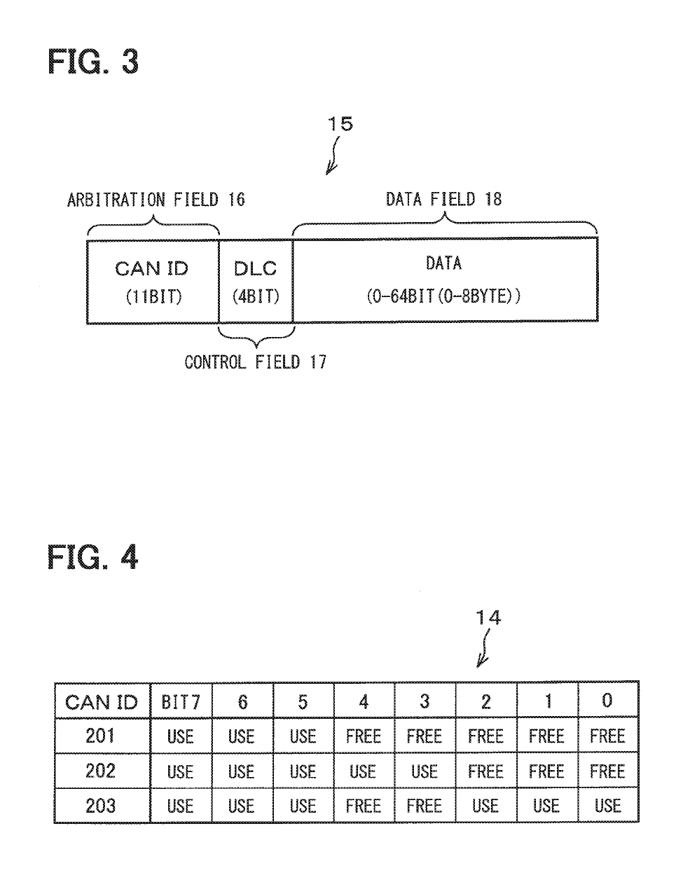

FIG. 3 shows a format of a data frame 15 employed in CAN. A format area of the data frame 15 is divided into an arbitration field 16, a control field 17, and a data field 18 for storing data. The data frame 15 may have a further field, but the explanation will be omitted.

The arbitration field 16 is a field indicating a type of data and an order of priority, and usually stores 11-bit identification number (ID), which is known as CANID. The control field 17 may include a 4-bit data length code (DLC). The DLC indicates a predefined byte number of data to be stored in the data field, and a maximum of settable byte number is 8 bytes. The data field 18 stores data that is actually transmitted or received, and can store 8 bytes of data in maximum byte-by-byte. In the present disclosure, normal data indicates target data to be transmitted or received corresponding to each CANID, that is, each identification number. Usually, the target data includes meaningful information.

In CAN protocol, internal bit information of the data frame is determined for each CANID. Thus, as shown in FIG. 4, each of the ECU 3 through ECU 5 prepares the management table 14 for CAN. In an example shown in FIG. 4, when CANID shows 201, higher three bits in one byte data are defined as use bits, and the rest of lower five bits are defined as free bits. The use bit means a use area, and the free bit means a free area. When CANID shows 202, higher five bits in the one byte data are defined as use bits, and the rest of lower three bits are defined as free bits. When CANID shows 203, higher three bits and lower three bits in the one byte data are defined as use bits, and the rest of middle two bits are defined as free bits. In the present embodiment, each of the ECU 3 through ECU 5 establishes a network regulation of the onboard network 2 by having the management table 14 for CAN.

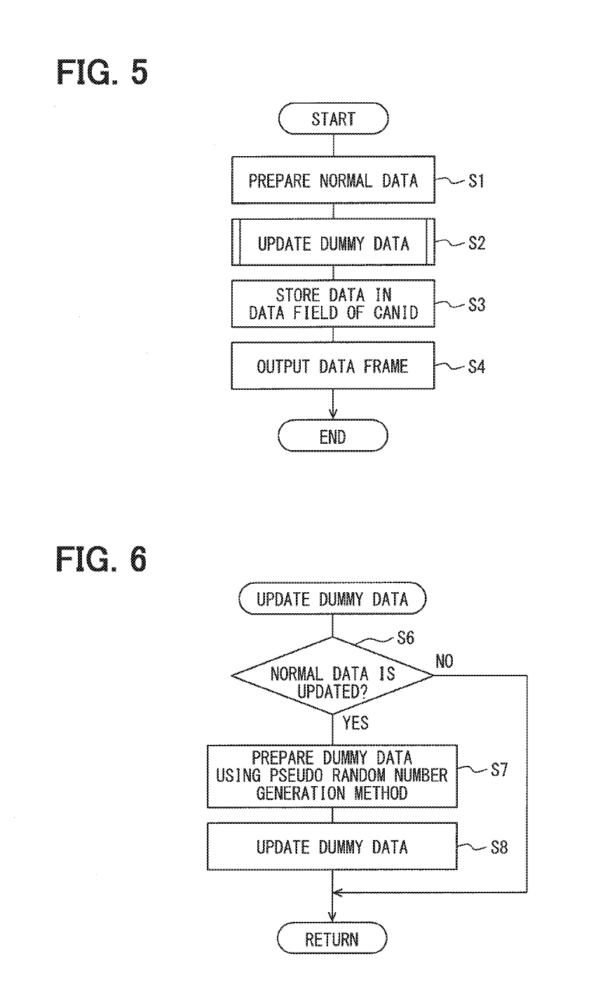

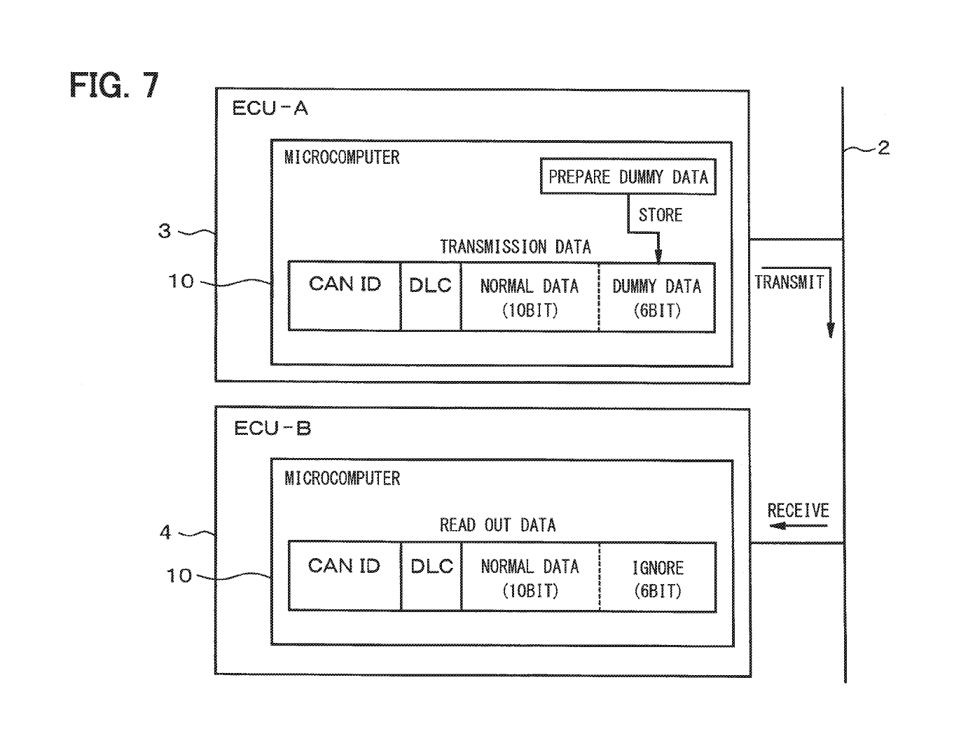

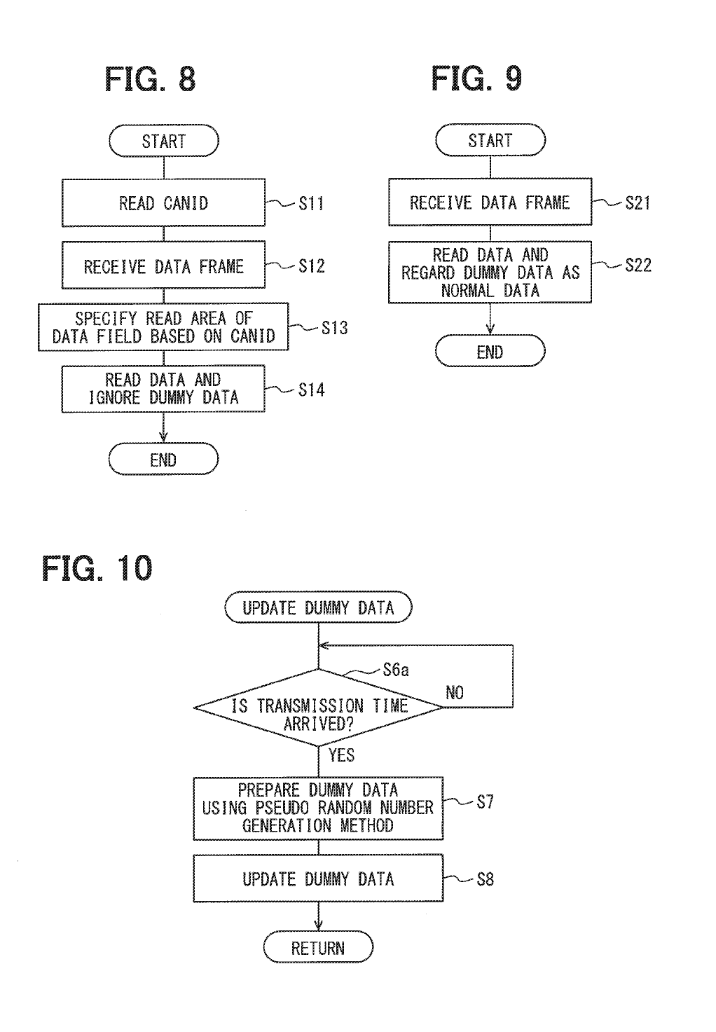

In the present embodiment, a dummy data is set in the free bit. That is, the dummy data is set in the free area. The following will describe a setting process of the dummy data. Hereinafter, suppose that the ECU 3 is disposed on a transmission side and is defined as a transmission node of the data frame, and the ECU 4 is disposed on a reception side and is defined as a reception node of the data frame. FIG. 5 shows a transmission process executed by the ECU 3 on the transmission side, and FIG. 6 shows an update process of the dummy data in detail. FIG. 7 shows a schematic view of a transmission and reception process. FIG. 8 shows a reception process executed by the ECU 4 on the reception side. FIG. 9 shows an outline of the transmission and reception process of the data.

As shown in FIG. 5, the microcomputer 10 of the ECU 3 prepares a normal data in S1, and updates the dummy data in S2. In S3, the microcomputer 10 of the ECU 3 stores data prepared in S1 and S2 in a data field of CANID which is specified based on the management table 14. The microcomputer 10 of the ECU 3 outputs the data frame to the onboard network 2 in S4.

The microcomputer 10 of the ECU 3 updates the dummy data by executing a subroutine as shown in FIG. 6. The microcomputer 10 of the ECU 3 determines whether the normal data is updated in S6. When determining that the normal data is updated (S6: YES), the microcomputer 10 of the ECU 3 prepares the dummy data by using a pseudo random number generation method in S7. Thus, the information represented by the dummy data is meaningless. This pseudo random number generation method may include a linear congruential method. Then, the dummy data, which will be stored in the free bit of the data field, is updated in S8. The new dummy data is prepared by the pseudo random number generation method in S7, and there is no correlation between the new dummy data and the normal data. In short, the normal data is not used in the preparation of the dummy data. In the present embodiment, the dummy data is prepared without use of the normal data. Alternatively, the dummy data may also be prepared by employing the normal data.

When the microcomputer 10 of the ECU 3 determines that the normal data is not updated in S6 (S6: NO), the microcomputer 10 of the ECU 3 returns to the main process without updating the dummy data. As shown in FIG. 5, after updating the dummy data as needed, the microcomputer 10 of the ECU 3 transmits the data frame to the onboard network 2. For example, as shown in FIG. 7, the ECU 3 transmits a data frame including CANID, DLC, 10-bit normal data, and 6-bit dummy data to the onboard network 2 by the communication controller 11.

As shown in FIG. 8, the ECU 4 on the reception side executes the reception process. The ECU 4 reads CANID using the communication controller 11 in S11, and determines whether a destination of the data frame is the ECU 4 itself based on the value of CANID. When determining that the data frame is destined for the ECU 4, the ECU 4 receives the data frame in S12. At this time, the ECU 4 refers to the management table 14, and specifies a target read area of the data field in accordance with CANID in S13. That is, the ECU specifies the use bit of the data frame, and reads the data stored in the use bit in S14. Due to the data sharing of the management table 14 between the ECU 3 and the ECU 4, the ECU 4 is capable of reading the data of use bit in the data field without reading the data of free bit. With this configuration, the microcomputer 10 of the ECU 4 is capable of ignoring the dummy data set by the ECU 3. As a result, the ECU 4 is capable of reading the necessary normal data and discarding the dummy data. As shown in FIG. 7, the microcomputer 10 of the ECU 4 reads the normal data having 10-bit size, and ignores the rest data having 6-bit size.

For example, as shown in FIG. 1, suppose that the unauthorized device 6 is connected to the onboard network 2. In this case, the unauthorized device 6 may be connected to the onboard network 2 by the malicious third party or the like. When the unauthorized device 6 is connected to the onboard network 2, the unauthorized device 6 is capable of reading the data frame flowing on the onboard network 2. As shown in FIG. 9, when the unauthorized device 6 receives the data frame in S21, it is difficult to determine which bit stores the normal data in the data frame. Thus, even when the unauthorized device 6 reads the data in S22, the unauthorized device 6 is incapable of specifying the dummy data and regards the dummy data as the normal data. When the unauthorized device 6 regards the dummy data as the partial transmission data, the unauthorized device 6 may highly make incorrect determination on a length of the normal data.

The following will describe advantages provided by the present embodiment. The microcomputer 10 of the ECU 3 sets the dummy data in a previously defined free area of the format area, and transmits the normal data together with the dummy data. Thus, for example, when the unauthorized device 6 is connected to the onboard network 2 for malicious data reading, the unauthorized device 6 reads the normal data together with the dummy data. Thus, it is difficult for the unauthorized device 6 to analyze which data is the normal data, and the unauthorized device 6 may have difficulty in specifying and reading the normal data. In addition, the free area previously given in the format area is used without adding a data area. So, network communication traffic of the on board network 2 is prevented from being increased to the utmost extent.

Definition information about the free area of the free bit is shared between the ECU 3 and the ECU 4 by previously storing the management table 14 on both sides. Thus the definition information of the free area is preliminary defined for each CANID, that is, for each identification number defined in the management table 14. Thus, the microcomputer 10 of the ECU 4 on the reception side is capable of specifying the data stored in the free bit as the dummy data, and ignoring the data in the free bit since the data stored in the free bit is unnecessary data. Thus, the microcomputer 10 of the ECU 4 on the reception side only needs to read the data stored in the previously defined target read area, and additional new logic for determining the dummy data is not needed.

In the microcomputer 10 of the ECU 3 on the transmission side, the dummy data is updated each time the normal data is updated. With this configuration, a possibility that the unauthorized device 6 specifies the dummy data as part of the transmission data and incorrectly specifies the length of the normal data may be increased.

### Second Embodiment

FIG. 10 shows an update process of a dummy data according to a second embodiment of the present disclosure. In the present embodiment, a flowchart shown in FIG. 10 is executed instead of the flowchart shown in FIG. 6. In the present embodiment, as shown in FIG. 10, when determining that a preset transmission time of the normal data arrives in S6a (S6a: YES), the microcomputer 10 of the ECU 3 prepares the dummy data using pseudo random number generation method in S7, and updates the old dummy data stored in the data frame with the newly prepared dummy data in S8.

In short, in the microcomputer 10 of the ECU 3 on the transmission side, the dummy data may be updated in response to each arrival of the transmission time of normal data. In this case, even when the unauthorized device 6 succeeds in malicious data reading, the readout data is difficult to be correctly analyzed since the unauthorized device may incorrectly specify the dummy data as the data which has a correlation with the normal data.

### Other Embodiments

In another embodiment of the present disclosure, the electronic control apparatus according to the above-described embodiments can be applied not only to CAN, but also to a communication system employing a different protocol under a condition that a format defined by the different protocol includes an area for setting the dummy data.

The foregoing embodiments show that each of the ECU 3 through ECU 5 has the management table 14, and shares the management table 14 with one another. In another embodiment of the present disclosure, the management table 14 may be previously stored in another ECU or the like connected to the onboard network 2, and each of the ECU 3 through ECU 5 may refer to the management table 14 stored in another ECU via the onboard network 2.

In another embodiment of the present disclosure, a partial or overall function executed by the microcomputer 10 of each ECU 3, 4, 5 may be achieved in a hardware manner using a single integrated circuit (IC) or using multiple ICs.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

What is claimed is:

1. An electronic control apparatus comprising:
a dummy data setting section setting a dummy data in a free area of a format area that is previously defined, wherein the electronic control apparatus configures a communication system as a transmission node and stores normal data in the format area, the free area is a rest of the format area after the transmission node stores the normal data in the format area, and the communication system further includes a reception node; and
a transmission section transmitting the normal data together with the dummy data to the reception node via a network, wherein the reception node receives the normal data together with the dummy data via the network.

2. The electronic control apparatus according to claim 1, wherein
the normal data is transmitted and received corresponding to an identification number stored in the format area,
the free area is previously defined in the format area corresponding to the identification number, and
definition information of the free area in the format area is shared between the transmission node and the reception node by sharing a management table.

3. The electronic control apparatus according to claim 1, wherein
the dummy data setting section updates the dummy data when the transmission node updates the normal data.

4. The electronic control apparatus according to claim 1, wherein
the dummy data setting section updates the dummy data each time the transmission node transmits the normal data.

5. The electronic control apparatus according to claim 1, wherein
the reception node ignores the dummy data set in the free area.
